(19) United States
(12) Patent Application Publication
(10) Pub. No.: US 2026/0198501 A1
(43) Pub. Date: Jul. 16, 2026

(54) Antibacterial and Antiviral Coatings Containing Niobium- and Copper-Doped Titanium Dioxide

(71) Applicant: INM - Leibniz-Institut für Neue Materialien gemeinnützige GmbH, Saarbrücken (DE)

(72) Inventors: Peter William de Oliveira, Folking (FR); Peter König, Lebach (DE); Petra Herbeck Engel, Saarbrücken (DE); Sarah Schumacher, Saarbrücken (DE)

(21) Appl. No.: 19/134,252

(22) PCT Filed: Nov. 28, 2023
(86) PCT No.: PCT/EP2023/083302

§ 371 Date: May 30, 2025

(30) Foreign Application Priority Data
Dec. 2, 2022 (DE) 10 2022 131 949.0

(51) Int. Cl. A01N 59/20; A01N 25/12; A01N 59/16; C09D 1/00; C09D 5/14; C09D 7/61

(52) U.S. Cl. CPC A01N 59/20; A01N 25/12; A01N 59/16; C09D 1/00; C09D 5/14; C09D 7/61

(57) ABSTRACT

A process for the production of antibacterial and antiviral coatings with niobium and copper-doped titanium dioxide includes preparing a dispersion comprising Cu,Nb-doped TiO₂ particles; optional crushing of the particles in the dispersion; and applying the dispersion to a substrate.

### FIELD OF THE INVENTION

The invention relates to a process for the production of niobium and copper doped titanium dioxide particles and coatings thereof, a process for their production and their use.

Nb-doped TiO₂ (TNO) is mentioned in the literature as a substitute for indium tin oxide (ITO) for transparent conductive layers. This statement is based on the fact that sputtered layers of the material show similar optical and electrical properties to sputtered ITO layers. There are isolated attempts to synthesise the material using wet chemistry, e.g. in the production of a sol from precursors and subsequent spin or dip coating.

Nb-doped titanium dioxide particles TNO, which are pressed into conductive bodies, are known from WO 2019/129463 A1.

### Problem

The purpose of the invention is to provide a process that enables the production of Nb- and Cu-doped TiO₂ particles and layers.

### Solution

This problem is solved by the inventions with the features of the independent claims. Advantageous further embodiments of the inventions are characterised in the dependent claims. The wording of all claims is hereby made the content of this description by reference. The inventions also comprise all useful and in particular all mentioned combinations of independent and/or dependent claims.

The problem is solved by a process for the production of antiviral and antibacterial coatings comprising Cu, Nb-doped TiO₂ particles comprising the following steps:
a) Preparation of a dispersion comprising Cu, Nb-doped TiO₂ particles;
b) Optional crushing of the particles in the dispersion;
c) Application of the dispersion to a substrate.

In the following, individual process steps are described in more detail. The steps do not necessarily have to be carried out in the order indicated, and the method to be described may also include other steps that are not mentioned.

In a first step, a dispersion comprising Cu, Nb-doped TiO₂ particles is prepared.

In a preferred embodiment of the invention, these are nanoparticles. These are understood to be particles with a particle size of less than 200 nm. This means that in a random sample of at least 100 particles, at least 50% have a diameter of less than 200 nm (measured by TEM). Preferred is a particle size of not more than 100 nm (i.e. 50% in the range of not more than 100 nm), in particular not more than 50 nm, in particular from 1 to 200 nm, preferably from 1 to 100 nm, particularly preferably from 2 to 50 nm. Particles with a particle size of 2 to 30 nm and 2 to 20 nm are particularly preferred.

Preferably, in a random sample of at least 100 particles, all have a diameter of less than 200 nm, preferably less than 100 nm (measured with TEM), in particular after the optional comminution step.

The TiO₂ particles are Cu, Nb-doped TiO₂particles. Preferred are particles with a Cu and Nb content of up to 30 at % each based on the sum of Cu, Nb and Ti atoms, preferably up to 20 at % each. The content of Cu or Nb is preferably at least 2 at % each, preferably at least 4 at % each.

The particles can usually be produced in various ways, e.g. by flame pyrolysis, plasma processes, colloid techniques, sol-gel processes, controlled nucleation and growth processes, MOCVD processes and emulsion processes. These processes are described in detail in the literature.

The dispersion also comprises at least one solvent. These can be, for example, water or organic solvents or mixtures thereof. Preferred are organic solvents, such as alcohols, ethers, ketones, amides or mixtures thereof. Preferred are solvents with a boiling point of below 200° C., in particular between 30° C. and 200° C. Preferred are aliphatic alcohols (C₁-C₆ alcohols), such as ethanol, 1-propanol, i-propanol, sec-butanol, tert-butanol, 2-isobutyl alcohol, n-butanol and the pentanol isomers, in particular 1-pentanol, diols such as ethylene glycol, 1,3-propanediol or ethers of these above compounds such as ethylene glycol monoisopropyl ether (2-isopropoxyethanol).

Depending on the desired coating, the dispersion can comprise matrix materials, for example inorganic matrices, such as inorganic brines like acidic or basic water glass, such as sodium, potassium or lithium water glass, or silica sol.

The dispersion can also include other additives, such as wetting agents, fillers, colour pigments, dyes, cross-linking agents, adhesion promoters and starters, which are used for cross-linking, for example.

Preferably, the dispersion also comprises at least one wetting agent which stabilises the dispersion, such as phosphoric esters.

The dispersion preferably has a particle content of more than 10 wt. %, preferably between 10 and 50 wt. %. A total solids content (gravimetric, after 2 h at 500° C.) of 10 to 50 wt. % is preferred.

In an optional step, the particles of the dispersion are comminuted. This is preferably done by mechanical comminution, particularly preferably in a ball mill. This step is particularly important if the coating according to the invention is to be applied to transparent substrates or is to be transparent itself.

The dispersion is applied to a substrate. The substrate can be any conventional material. Examples include metal, rock, wood, paper, textiles, leather, ceramic, glass, enamel, rubber or plastic. Metal includes metal alloys and examples are steel, including stainless steel, chromium, copper, titanium, tin, zinc, brass and aluminium. Examples of plastic include polymethyl methacrylate, polyethylene, polypropylene, polyacrylates such as polymethyl acrylate, polyvinyl butyral or polycarbonate. Examples of glass are float glass, borosilicate glass, lead crystal or silica glass. Paper and textiles can be made from plant, animal or synthetically produced fibres. Stone includes natural stone, such as marble, granite or sandstone, and artificial stone, such as concrete and mortar.

In principle, the coating is suitable for all substrates or objects. The object can consist of one material or several parts made of different materials. The object can at least partially have a surface layer to be coated. The coating according to the invention can be applied to the entire surface of the substrate. Depending on requirements, only parts of the substrate can be provided with the coating. This may result, for example, from the fact that these parts are particularly exposed to microorganisms or viruses or that a biofilm is particularly undesirable for these parts.

The substrate can be pretreated in the usual way, e.g. to achieve cleaning, degreasing or better adhesion with the coating.

The substrate can be provided with a surface layer, e.g. by metallisation, enamelling or painting. It is often advisable to provide the substrate with a primer consisting of a conventional lacquer.

Of course, if only part of the substrate is to be coated, the part of the substrate to be coated can first be coated separately and then joined together to form the finished article.

The dispersion can be applied to the substrate in any standard way. All common wet-chemical coating processes can be used. Examples include centrifugal coating, (electro)dip coating, doctoring, spraying, spinning, drawing, spinning, casting, rolling, brushing, flood coating, film casting, knife casting, slot coating, meniscus coating, curtain coating, roller application or conventional printing processes such as screen printing or flexoprinting. The amount of coating composition applied is selected to achieve the desired coating thickness.

After application of the dispersion, drying may take place, e.g. at ambient temperature (below 40° C.).

The coating, which may be pre-dried, is generally subjected to heat treatment in order to dry and/or harden the coating. The conditions selected for this depend on the substrate.

This can be, for example, a temperature treatment at over 350° C. for at least one hour. Such treatment removes organic residues.

The resulting coatings have several favourable properties due to the double doping. For example, the Cu,Nb-doped TiO₂particles have an antiviral and antibacterial effect when exposed to visible light as well as in the absence of light. The coatings can also be produced in a simple manner without having to combine several active additives. The particles are also easy to produce.

The coatings according to the invention are generally suitable for all objects or parts thereof that are to have antibacterial and antiviral properties. Preferably, the coatings according to the invention are transparent and/or on transparent substrates.

The doped particles according to the invention are preferably produced by a sol-gel process to form the particles. In the sol-gel process, hydrolysable compounds are usually hydrolysed with water, optionally under acidic or basic catalysis, and optionally at least partially condensed. The hydrolysis and/or condensation reactions lead to the formation of compounds or condensates with hydroxy groups, oxo groups and/or oxo bridges, which serve as precursors. The sol containing the particles according to the invention can be obtained by suitable adjustment of the parameters, e.g. degree of condensation, solvent, temperature, water concentration, duration or pH value.

The hydrolysis and condensation reaction is preferably carried out in such a way that the hydrolysable compounds are not completely hydrolysed and particles are formed, i.e. the particles formed still have hydrolysable groups on the surface. The person skilled in the art, who is given the task of not completely hydrolysing the hydrolysable compounds, knows how to achieve this by suitably adjusting the above-mentioned parameters. Some preferred conditions are explained below. This process produces particles which are easily redispersible due to the non-hydrolysed groups on their surface. In addition, the group can be easily controlled by the choice of compounds and solvents used.

The hydrolysis and condensation can be carried out in a solvent, but they can also be carried out without a solvent, whereby solvent or other liquid components can be formed during the hydrolysis, e.g. during the hydrolysis of alcoholates. The removal of the solvent may include the removal of any liquid components present. Removal of the solvent can be carried out, for example, by filtration, centrifugation and/or drying, e.g. evaporation.

Preferably, the hydrolysis is carried out in a solvent. The solvent used is an organic solvent in which the hydrolysable titanium compound, as well as the preferably also hydrolysable niobium compound and copper compound, are preferably soluble. The solvent is also preferably miscible with water. Examples of suitable organic solvents include alcohols, ketones, ethers, amides and mixtures thereof. Alcohols are preferably used, preferably lower aliphatic alcohols (C₁-C₆ alcohols), such as ethanol, 1-propanol, i-propanol, sec-butanol, tert-butanol, isobutyl alcohol, n-butanol and the pentanol isomers, in particular 1-pentanol, with methanol and ethanol, in particular ethanol, being preferred. Preferably, an alcohol with the same hydrocarbon chain as the preferred alkoxides is used.

Preferably, the components are dissolved before hydrolysis.

Preferably, hydrolysis is carried out with a sub-stoichiometric amount of water, i.e. the molar ratio of water to hydrolysable groups of the at least one hydrolysable titanium compound is less than 1, preferably not more than 0.8, particularly preferably not more than 0.6 and even more preferably not more than 0.5, in particular less than 0.5. Preferably, the molar ratio is greater than 0.05 and more preferably greater than 0.1. A preferred molar ratio is, for example, 0.1 to 0.5.

As mentioned, hydrolysis can be catalysed by acidic or basic methods, with acidic catalysis being preferred. Inorganic or organic acids can be used. Inorganic acids are particularly preferred, as the reaction may be incomplete with organic acids such as acetic acid. If nitric acid or sulphuric acid is used, additional doping with N or S atoms may occur. Particularly preferred is hydrochloric acid (HCl), especially with a concentration of at least 2 mol/l, preferably at least 10 mol/l, in particular concentrated hydrochloric acid. Concentrated hydrochloric acid is a solution with at least 10 mol/l, in particular at least 12 mol/l. Preferably, the acid, which in the case of hydrochloric acid is an aqueous solution of HCl, is the only water added to produce the particles.

The hydrolysis can be carried out at room temperature (about 23° C.), but is preferably carried out under heating, e.g. to at least 60° C., preferably at least 100° C. or at least 200° C. In a particularly preferred embodiment, hydrolysis is carried out under heating and pressure (hydrothermal reaction), particularly preferably by heating in a sealed container (autogenous pressure).

In a preferred embodiment of the invention, hydrolysis is carried out in a sealed container at autogenous pressure and a temperature of 200 to 300° C., preferably 220 to 260° C.

The hydrolysis is carried out until particles according to the invention are obtained. A duration of 30 minutes to 48 hours is preferred, preferably 12 hours to 36 hours, in particular 20 to 36 hours.

However, suitable reaction conditions naturally depend on the starting compounds used, so that, for example, depending on the stability of the starting compound, a wide range of suitable conditions may be appropriate. The skilled person can easily select suitable conditions depending on the selected compounds.

Alkoxides can be used as hydrolysable compounds or precursors, but also other compounds that are capable of hydrolysis, e.g. precursors containing acyl groups or complexed precursors such as ß-diketone complexes such as acetylacetonates. Organyls with metal-carbon compounds can also be used.

Preferably, the hydrolysable compound is a titanium compound of the general formula MXₙ (I), wherein M is Ti and X is a hydrolysable group which may be the same or different, wherein two groups X may be replaced by a bidentate hydrolysable group or an oxo group, or three groups X may be replaced by a tridentate hydrolysable group, and n corresponds to the valency of the element M and is 4 in the case of Ti. If M stands for Nb, n is usually 5. If M stands for Cu, n is usually 2.

Group X is preferably a group with a low mass. This ensures that the surface of the particles is not covered with groups that are difficult to remove. Examples of preferred groups are, for example, halogen (F, Cl, Br or I, in particular Cl and Br) alkoxy (preferably C₁₋₆ alkoxy, in particular CH₁₋₄ alkoxy, such as methoxy, ethoxy, n-propoxy, i-propoxy, butoxy, i-butoxy, sec-butoxy and tert.-butoxy), aryloxy (preferably C₆₋₁₀ aryloxy, such as phenoxy), acyloxy (preferably C₁₋₆ acyloxy, such as acetoxy or propionyloxy) or alkylcarbonyl (preferably C₂₋₇ alkylcarbonyl, such as acetyl). Preferred are small groups with up to 3 carbon atoms, for example C₁₋₃ alkoxy, such as ethoxy, n-propoxy, i-propoxy, C₁₋₃ acyloxy, such as acetoxy or propionyloxy, C₁-C₃-alkenyloxy, such as vinyl or allyloxy, C₁-C₃-alkynyloxy or C₂₋₃-alkylcarbonyl, such as acetyl.

The hydrolysable metal or semi-metal compounds, e.g. those of formula (I) above, may also have complexing radicals, such as ß-diketone and (meth)acrylic radicals. Examples of suitable complexing agents are unsaturated carboxylic acids and ß-dicarbonyl compounds, such as methacrylic acid, acetylacetone and ethyl acetoacetate.

In a preferred embodiment, the Nb compound added for doping is also a compound of the formula (I), where M then stands for Nb. This allows it to be better incorporated into the particles.

In a preferred embodiment, the Cu compound added for doping is a compound of formula (I), where M then stands for Cu

Examples of compounds are Ti(OCH₃)₄, Ti(OC₂H₅)₄, Ti(O-n-C₃H₇)₄, Ti(O-i-C₃H₄)₄, TiCl₄, NbCl₅, Nb(OCH₃)₅, Nb(OC₂H₅)₅, Nb(O-n-C₃H₇)₅, Nb(O-i-C₃H₇)₅, Nb(O-i-C₃H₇)₄thd (thd=2,2,6,6-tetramethylheptane-3,5-dionate), Cu(acac)₂, copper(II)-tert.-butyl acetoacetate, copper(II)-2,2,6,6-tetramethyl-3,5-heptanedionate, Cu(OCH₃)₂, Cu(OOCH)₂, Cu(OOCCH₃)₂

Preferably, all Nb and Ti compounds of formula (I) used are alkoxides or complexes comprising alkoxides. Preferably they comprise only groups of carbon, hydrogen and oxygen. Examples of preferred compounds are: Ti(OCH₃)₄, Ti(OC₂H₅)₄, Nb(OCH₃)₅ and Nb(OC₂H₅)₅. The copper compounds used are preferably carboxylates or ß-dicarbonyl compounds, in particular Cu(acac)₂. Alkoxides are chemically more similar and allow the production of particularly uniform particles, especially when an alcohol is also used as a solvent.

Preferably, the composition does not contain any other metal compounds.

The Cu, Ti and Nb compounds are preferably used according to the desired degree of doping.

After hydrolysis, the particles obtained are isolated by removing the solvent and obtained as a powder.

It may be necessary to neutralise the excess acid beforehand by adding lye, in particular sodium hydroxide.

Preferably, the particles are washed with deionised water until the wash water has a conductivity of no more than 20 uS/cm.

In a preferred embodiment, the particles are then calcined. This removes organic residues.

Preferably, the particles are subjected to a temperature treatment in an oxygen-containing atmosphere. The temperature is at least 200° C., preferably at least 400° C. A temperature of 200° C. to 900° C. is preferred, preferably 400° C. to 800° C., particularly preferably 450° C. to 800° C. Particularly good results were obtained with a treatment of 450° C. to 750° C.

The temperature treatment is carried out until the organic components have been removed to a sufficient extent. Depending on the amount of particles, the treatment can take between 1 minute and 25 hours, preferably 30 minutes to 2 hours, whereby this is the time at which the desired temperature is maintained. Preferably, the particles are heated to the target temperature within up to 4 hours.

The temperature treatment takes place in an oxygen-containing atmosphere. The atmosphere should therefore contain a sufficient proportion of oxygen. A proportion of at least 5% by volume is preferred, preferably at least 20% by volume. The other components preferably include gases that are unreactive under the conditions, such as nitrogen or argon. Up to 0.1% by volume of other gaseous components may also be present.

The temperature treatment can also simply be carried out in air.

The invention also relates to a process for the production of Cu, Nb-doped TiO₂ particles according to a preferred embodiment of the process described above.

A mixture comprising at least one hydrolysable titanium compound, preferably of formula (I), and at least one hydrolysable niobium compound, preferably of formula (I), at least one hydrolysable copper compound, preferably of formula (I), in an organic solvent and water in a sub-stoichiometric amount, based on all hydrolysable groups present, is used. This mixture is treated under autogenous pressure at 200 to 300° C. to form Cu, Nb-doped TiO₂ particles. The treatment can be carried out for 12 to 36 hours. By removing the solvent, a powder of Cu, Nb-doped TiO₂ particles can be obtained.

In a preferred embodiment, the hydrolysable Nb and Ti compounds are alkoxide compounds with 1 to 3 carbon atoms and the Cu compounds are β-diketone compounds.

The invention also relates to Cu, Nb-doped titanium dioxide particles produced by the process according to the invention.

Further details and features can be found in the following description of preferred embodiments in conjunction with the subclaims. The respective features may be realised individually or in combination with one another. The possibilities for solving the problem are not limited to the embodiment examples. For example, range specifications always include all intermediate values—not mentioned—and all conceivable subintervals.

### EXAMPLES

### Production of the Particles

The precursors Ti(OEt)₄ (65.7 g, 288.0 mmol) and Nb(OEt)₅ (for 5 at % Nb: 5.09 g, 16.0 mmol) and copper (II) acetylacetonate Cu(acac)₂ (4.19 g; 16.0 mmol) were weighed together in the glovebox and then mixed inside or rapidly outside the glovebox with abs. ethanol (470 ml). This mixture was stirred overnight (approx. 18 h). Concentrated hydrochloric acid (37%, 6.54 g) was then added quickly while stirring. After a further 3 h of stirring, the reaction solution was evenly distributed (approx. 136 ml each) into four 200 ml Teflon containers. These were screwed tightly into steel containers (at least 35 Nm) and heated to 240° C. for 25 h in heating blocks. After complete cooling, the clear supernatant was removed and the solids were poured into 500 ml centrifuge containers with water. After adding 0.5 mL NaOH (3 molar) to neutralise the HCl, the samples were washed at least three times with deionised water until the wash water reached a conductivity of no more than 20 μS/cm. The solid was then transferred to a flask with as little water as possible, frozen in liquid nitrogen and freeze-dried.

The resulting powder was then calcined at 500° C. and air for one hour.

### Production of the Coating Sol

The particles obtained in example 1 (9 g) were slurried in 2-isopropoxyethanol (36 g) and Byk W 9010 (1.8 g) and ground using a Retsch PM 400 planetary ball mill in 2×50 ml aluminium oxide grinding vessels with zirconium oxide grinding balls (ø 0.3 mm) for 4 h at 400 rpm without changing direction. The solids content of the resulting dispersion was determined gravimetrically at 19.5% after two hours at 500° C.

The resulting dispersion was filtered through Whatman ReZist 30/GF92 syringe filters and applied by spin coating. A 5 cm×5 cm borofloat glass disc (thickness 2 mm) was used as the substrate. For each step, 0.7 mL of the filtered dispersion was applied. The following parameters were selected:
Step 1:350 rpm; Acc. 100 rpm/sec; Duration 5 sec. Spinning on
Step 2:1000 rmp; Acc 500 rmp/sec; Duration 60 sec. spinning
Step 3:350 rmp; Acc 300 rpm/sec; Duration 5 sec. Spinning off

The layers were dried for one hour at 400° C. and then characterised using ellipsometry and white light interferometry.

### Antiviral and Antibacterial Tests

The antibacterial/viral effect of the embodiments as a coating is shown schematically in the figures. Identical reference numerals in the individual figures denote identical or functionally identical elements or elements that correspond to each other in terms of their functions. In detail:

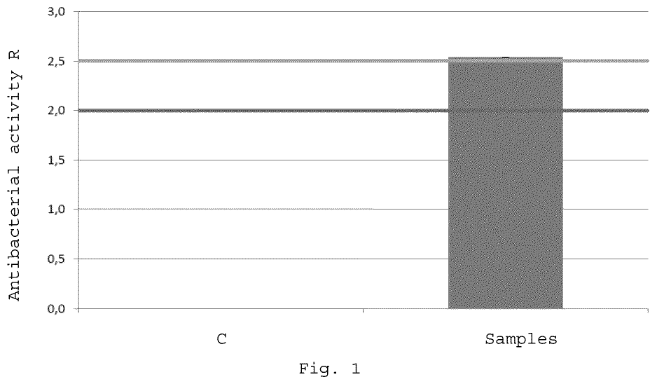

FIG. 1 Measurement of antibacterial properties with illumination according to Table 1; the upper thick line shows Rₘₐₓ, the lower thick line shows R=2.0

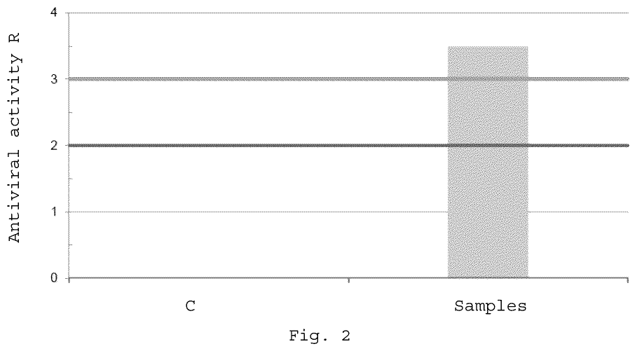

FIG. 2 Measurement of antiviral properties with illumination according to Table 1; the upper thick line shows R=3.0, the lower thick line shows R=2.0

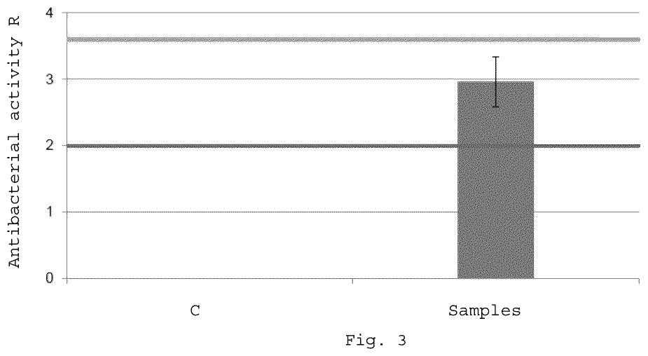

FIG. 3 Measurement of antibacterial properties without illumination according to Table 1; the upper thick line shows Rₘₐₓ, the lower thick line shows R=2.0

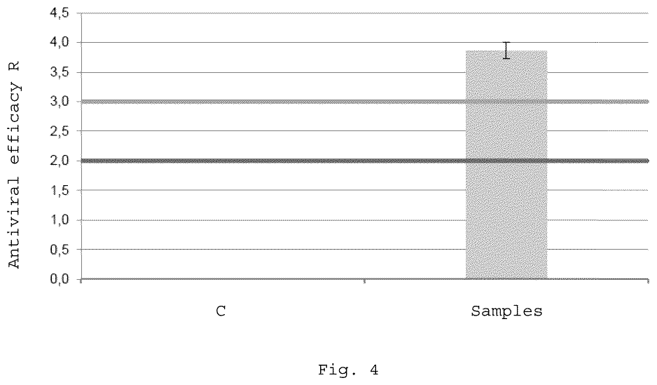

FIG. 4 Measurement of antiviral properties without illumination according to Table 1; the upper thick line shows R=3.0, the lower thick line shows R=2.0

The conditions are shown in Table 1.

The antibacterial activity or antiviral efficacy is given as an R value. The meaning of the values for the antibacterial tests is given in Table 2 and for the antiviral tests in Table 3.

The R value is calculated using the formula

$$R = ( {U}_{t} - {U}_{0} ) - ( {A}_{t} - {U}_{0} ) = {U}_{t} - {A}_{t} * R .$$

U₀ is the mean value of the logarithm of the phage titres after 0 hours of contact with the non-antiviral control sample. Uₜ is the mean value of the logarithm of the phage titres after 24 hours of contact with the non-antiviral control sample. Aₜ is the mean value of the logarithm of the phage titres after 24 hours of contact with the antiviral sample. Rₘₐₓ is the maximum value from the above calculation. The antibacterial activity was determined in the same way.

FIG. 1 shows the result of the measurement of the antibacterial properties with illumination. The samples show a very good antibacterial effect compared to the control (C) with an R-value of over 2.5.

FIG. 2 shows the result of the measurement of the antiviral properties with illumination. Compared to the control (C), the samples exhibit complete antiviral efficacy with an R value of over 3.

FIG. 3 shows the result of the measurement of the antibacterial properties without illumination. The samples still have a good antibacterial effect compared to the control (C) with an R-value of almost 3.0.

FIG. 4 shows the result of the measurement of the antiviral properties without illumination. Compared to the control (C), the samples exhibit complete antiviral efficacy with an R value of over 3.5.

The particles according to the invention, or coatings containing them, therefore exhibit good to very good antibacterial and antiviral properties with and without illumination.

The particles are easily accessible and can be produced in a simple manufacturing process. The photocatalytic activity can also reduce the deposition of organic material, so that the coating is antibacterially and antivirally active for longer than pure copper-containing coatings.

TABLE 1

| Test for antibacterial | Test for antiviral |
|---|---|
| properties | properties |
| Analogue to ISO 22196: 2011 | Analogue to ISO 21702 |
| Strain: Staphylococcus aureus | Test virus: phi6 DSM 21482 |
| DSM 346 | Host bacterium: Pseudomonas |
| | sp. DSM 21482 |
| Incubation: 24 h at 35° C. | Incubation: 24 h at 30° C. |
| with/without illumination | with/without illumination |
| Light source: Osram L 18 | Light source: Osram L 18 |
| W/865 fluorescent tubes | W/865 fluorescent tubes |
| The samples were covered with | The samples were covered |
| PET film “Hostaphan” and | with PET film “Hostaphan” |
| soda-lime glass during | during incubation. |
| incubation (translucent from | |
| approx. 310/320 nm). | |

TABLE 2

| | |
|---|---|
| R < 0.5 | No antibacterial effect |
| 0.5 <= R < 2.0 | Weak antibacterial effect |
| 2.0 <= R < Rₘₐₓ | Good antibacterial effect |
| R = Rₘₐₓ | Very good antibacterial effect |

TABLE 3

| | |
|---|---|
| R < 2.0 | No antiviral efficacy |
| 2.0 <= R < 3.0 | Low antiviral efficacy |
| R >= 3.0 | Complete antiviral efficacy |

1. A process for the preparation of antiviral and antibacterial coatings comprising Cu, Nb-doped TiO₂ particles, comprising:
preparing a dispersion comprising Cu, Nb-doped TiO₂ particles;
optional crushing of the particles in the dispersion; and
applying the dispersion to a substrate.

2. Process according to claim 1, wherein the particles have a particle size of less than 200 nm.

3. Process according to claim 1, wherein the particles have an Nb content and Cu content of up to 30 at % each.

4. Process according to claim 1, wherein the particles are produced by a sol-gel process.

5. Process according to claim 1, wherein the particles have been prepared by hydrolysis with a substoichiometric amount of water.

6. Coating produced by the process according to claim 1.

7. Process for the preparation of Cu, Nb-doped titanium dioxide particles comprising:
preparing a mixture comprising at least one hydrolysable titanium compound, at least one hydrolysable copper compound and at least one hydrolysable niobium compound in an organic solvent and water in a sub-stoichiometric amount, based on all hydrolysable groups present; and
treating the mixture at 200° C. to 300° C. under autogenous pressure to form Cu, Nb-doped titanium dioxide particles.

8. Cu, Nb-doped titanium dioxide particles produced by the process according to claim 7.
